(19) United States
(12) Patent Application Publication
(10) Pub. No.: US 2024/0424458 A1
(43) Pub. Date: Dec. 26, 2024

(54) NOVEL MIXER FOR EMULSION PRODUCTS

(71) Applicant: Illinois Tool Works Inc., Glenview, IL (US)

(72) Inventors: John H. Lee, Glenview, IL (US); Ryan P. Cyboron, Glenview, IL (US)

(73) Assignee: Illinois Tool Works Inc., Glenview, IL (US)

(21) Appl. No.: 18/748,185

(22) Filed: Jun. 20, 2024

Related U.S. Application Data
(60) Provisional application No. 63/522,445, filed on Jun. 22, 2023.

(51) Int. Cl. B01F 27/231; B01F 23/41; B01F 23/43; B01F 27/09; B01F 27/61; B01F 27/70; B01F 27/90; B01F 35/32; B01F 35/43

(52) U.S. Cl. CPC B01F 27/231; B01F 23/41; B01F 23/43; B01F 27/09; B01F 27/61; B01F 27/70; B01F 27/90; B01F 35/3204; B01F 35/43

(57) ABSTRACT

A container mixer is provided that includes a single container moveable between a vertical position and a horizontal position. A mixing apparatus includes at least one blade disposed on a shaft that is rotatably driven by a motor. A frame is configured to support the container and facilitate movement of the container from the vertical position to the horizontal position. A container mixer is also provided that includes a single container having a first end, at least one side wall extending from the first end, and a second end. A mixing apparatus is moveable relative to the container between a vertical position where the shaft is inserted through the second end of the container and a horizontal position wherein the shaft is inserted through the through hole in the side wall of the container. A method of preparing an emulsion product therewith is also provided.

### RELATED APPLICATIONS

This application claims priority benefit of U.S. Provisional Application Ser. No. 63/522,445 filed Jun. 22, 2023; the contents of which are hereby incorporated by reference.

### FIELD OF THE INVENTION

The present invention relates to a mixer for mixing emulsion products, and more particularly to an industrial mixer having adjustable positions for mixing emulsion products that undergo viscosity changes during their manufacturing processes.

### BACKGROUND OF THE INVENTION

An emulsion product is made from a mixture of two immiscible substances such as oil-in-water or water-in-oil emulsion. In an emulsion, one substance is dispersed in the other substance. When emulsion products are produced properly, their storage stability is good, often making them storage stable for such as 12 months. When they are not produced properly, emulsion products may have separation problems where the two immiscible substances separate out from one another. Ensuring a proper process method, equipment, ingredients, and mixing rate are critical to form a storage stable emulsion product.

There is wide use of emulsion products in several industries including as coating industry, food industry, immunology industry, paint industry, and others. For example, oil-in-water emulsions have been used as vaccine adjuvants because of their ability to elicit a differentiated immunogenic response compared to traditional aluminum salt adjuvants (A). Many mold release emulsion products are required to have stable emulsions with small particle sizes, such as less than 500 nanometers (nm). Emulsion products with smaller particles demonstrate better stability without separation problems between the water phase and the oil phase. Vaccine emulsion products are usually processed with an expensive homogenizer and microfluidizer with high pressure (such as 28,000 psi) for the oil-in-water vaccine emulsion adjuvants (A). Emulsion vaccine products usually have less than 600 nm particle sizes, in which emulsion with 200-600 nm particles can be easily recognized by lymph node antigen-presenting cells with Th1-type cellular immunity (B and C). Mold release emulsion products with small particle sizes (such as less than 500 nm) have more stability for long storage times such as twelve months.

There are several problems typically associated with emulsion product processes such as viscosity change, mixing area/volume limitation, micelle formation, stickiness, gravity, labor, and others. When producing an emulsion, the mixture undergoes a viscosity change, typically from a low viscosity liquid to a high viscosity gel or semi-wet solid with the oil phase addition, and then back to a low viscosity liquid with the water phase addition. These viscosity changes from low to very high and back to low, makes it very difficult to adequately mix, particularly given the limitations of existing mixers, which are explained below.

Mixers typically used for mixing industrial products including emulsion products are available in vertical form and horizontal form. Expensive homogenizers are commonly used to form uniform emulsion products at high mixing speeds such as 7,000 or 10,000 RPM. A vertical mixer has its advantages and disadvantages. For example, a vertical mixer is typically good for mixing low viscosity liquid materials. Its mixing speed can be increased to high speed such as 1,000 RPM or more, but a vertical mixer is typically not good for mixing high viscosity materials given several factors such as high viscosity, gravity, stickiness, and uniformity requirements. A horizontal mixer also has its advantages and disadvantages. That is, a horizontal mixer is good at mixing high viscosity materials, but its speed is usually limited to only at low or middle speeds, such as 50-200 RPM. Typical horizontal mixers have a wide blade to cover more mixing volume and area. However, horizontal mixers experience leakage from the mixing shaft holder, particularly when the material being mixed has a lower viscosity.

Over the years, various attempts have been made to improve emulsion products and vertical and horizontal mixers. However, these existing solutions are prone to breakdowns, which limit productivity and cause costly production delays. Existing solutions also fail to provide uniform mixing for products that undergo viscosity changes during their formation, such as emulsions, which can lead to product waste. Existing emulsion processes often use two mixers. One mixer is for dispersion at a high speed and another mixer is for scraping the sides. Both mixers need high power. Another solution for obtaining uniform emulsion products is to use a horizontally oriented mixer when the viscosity is high and to transfer the mixture into a vertically oriented mixer when the viscosity is low. However, such a solution requires two mixing equipment and additional labor to transfer the mixture from one container to another container.

Thus, there exists a need for a reliable mixer capable of uniformly mixing emulsions and other mixtures that undergo viscosity changes during their formation and that do not require additional processing steps such as transferring the mixture between horizontal and vertical containers.

### SUMMARY OF THE INVENTION

A container mixer is provided that includes a single container defining a volume therein. The volume is configured to receive and contain materials. The container is moveable between a vertical position and a horizontal position. A mixing apparatus includes at least one blade disposed on a shaft that is rotatably driven by a motor. The at least one blade is positioned within the volume of the container and configured to rotate therein to mix the materials within the volume of the container. A frame is configured to support the container and facilitate movement of the container from the vertical position to the horizontal position.

A container mixer is also provided that includes a single container having a first end, at least one side wall extending from the first end, and a second end. The container defines a volume therein that is configured to receive and contain materials. The at least the second end one side wall has a through hole therein. A mixing apparatus is provided that includes at least one blade disposed on a shaft that is rotatably driven by a motor, the at least one blade configured to be positioned within the volume of the container and configured to rotate therein to mix the materials within the volume of the container. The mixing apparatus is moveable relative to the container between a vertical position where the shaft is inserted through the second end of the container and a horizontal position wherein the shaft is inserted through the through hole in the at least one side wall of the container.

A method of preparing an emulsion product is also provided that includes a surfactant and water being mixed in a mixer with a slope or vertical position relative to a floor. Oil-phase compound(s) are mixed therein to build viscosity with a slope or a horizontal position. Partial water with or without water-phase compound(s) is added to reduce viscosity. The mixer is converted to a vertical position. Then more water with or without water-phase compound(s) is added with mixing to form the emulsion product.

### BRIEF DESCRIPTION OF THE DRAWINGS

The present invention is further detailed with respect to the following figures that depict various aspects of the present invention.

FIG. 1A is a cross sectional side view of a mixer in a vertical position according to embodiments of the present invention;

FIG. 1B is a cross sectional side view of the mixer of FIG. 1A in a sloped position according to embodiments of the present invention;

FIG. 1C is a cross sectional side view of the mixer of FIG. 1A in a horizontal position according to embodiments of the present invention;

FIG. 2 is a side view of a drum mixer as an example in a sloped position according to embodiments of the present invention; and

FIG. 3 is a top view of a drum mixer according to embodiments of the present invention.

FIG. 4A is a perspective view of a mixer according to embodiments of the present invention with a mixing apparatus provided in a vertical position relative to the cylinder container; and

FIG. 4B is a perspective view of the mixer of FIG. 4A with the mixing apparatus provided in a horizontal position relative to the cylinder container.

FIG. 5A is a perspective view of a mixer according to embodiments of the present invention with a mixing apparatus provided in a vertical position relative to the square container; and

FIG. 5B is a perspective view of the mixer of FIG. 5A with the mixing apparatus provided in a horizontal position relative to the square container.

### DESCRIPTION OF THE INVENTION

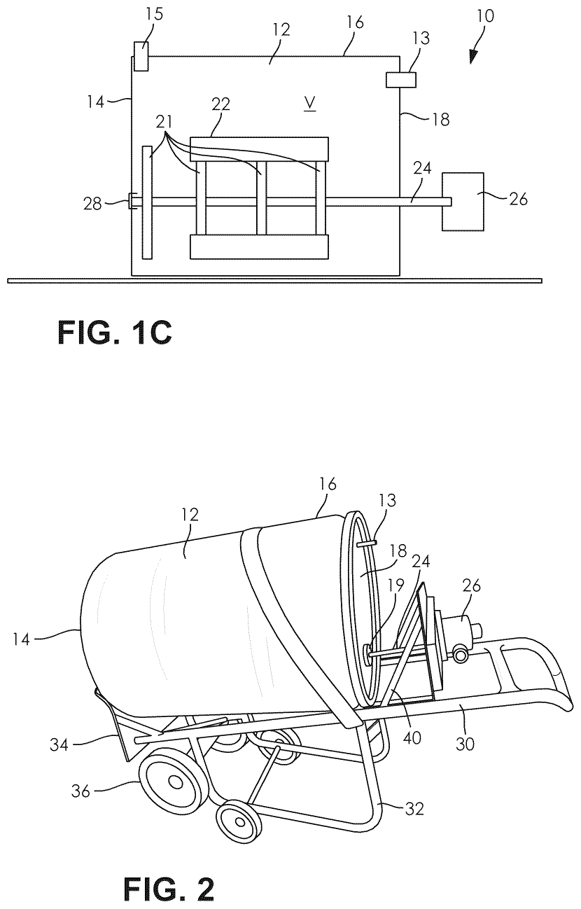

The present invention has utility as a reliable mixer capable of uniformly mixing emulsions and other mixtures that undergo viscosity changes during their formation and that do not require additional processing steps such as transferring the mixture between containers. According to embodiments, the present invention provides a container-mixer having adjustable positions for mixing emulsion products that undergo viscosity changes during their manufacturing processes. The container can be any volume such as a small tank, bucket, drum, tote, or large tank. These sizes can cover less than 3 gallons, between 3 to 20 gallons, 20 to 100 gallons as well as 100 gallons and above. A drum mixer as an example is shown in FIG. 2.

Embodiments of the present invention overcome the disadvantageous problems associated with vertical and horizontal mixers described above. Advantageously, embodiments of the present invention provide a single container that is equipped to uniformly mix materials that undergo viscosity changes during their mixing process. According to embodiments, the inventive mixer is adjustable to ensure the best mixing position and features for both low viscosity materials and high viscosity materials. According to embodiments, this is accomplished either by movement of the container itself, movement of the mixing apparatus, or a combination of both. According to embodiments, the container has a vertical position, a sloped position (between 0-90 degrees), and a horizontal position, which is controlled by its supports manually, adjustably, or automatically. According to embodiments, when the viscosity of the mixture in the container increases, the container is oriented in the sloped or horizontal position, and when the viscosity of the mixture in the container is reduced, the container is oriented in the sloped or vertical position.

According to embodiments, the inventive container mixer is provided at a fixed angled position to accommodate mixing of both low viscosity materials and high viscosity materials.

According to further embodiments the single container is provided in a fixed position and includes an opening through the top and side thereof into which a mixing apparatus may be inserted. Thus, providing the ability to mix vertically, to mix horizontally or to mix between them while the container itself remains in a fixed position. Such embodiments may be particularly useful in large scale production contexts where movement of the container. It is impractical given the size and volume of the container such as a drum, tote, or large tank.

The present invention improves the process for forming emulsions or similar products that undergo viscosity changes during production by providing proper mixer position (sloped, horizontal or vertical position) and to reducing processing costs through low cost equipment, mixing speed reduction, simple mixing process, and less labor.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

According to embodiments, an inventive container mixer 10 includes a single container 12 having a first end 14, at least one side wall 16 extending from the first end 14, and a second end 18. The container defines a volume V therein that is configured to receive and contain a plurality of materials, for example those used in the manufacturing process of an emulsion. Embodiments of the inventive container mixer 10 additionally include a mixing apparatus 20 that includes at least one blade 21 and cross 22 disposed on a shaft 24 that is rotatably driven by a motor 26. The at least one blade 21 and cross 22 being positioned within the volume V of the container 12 and configured to rotate therein to mix the plurality of materials within the volume V of the container 12. According to other inventive embodiments, the at least one blade 21 includes up to five blades with partial or whole cross 22. Its bottom blade may be connected to other blades or by itself to have less resistance. The cross usually has two pieces at both sides with their balance. The two cross pieces are optional. According to some inventive embodiments, the motor 26 of the mixing apparatus is configured to operate at a speed such as between 50 RMP and 1,000 RMP usually. According to other inventive embodiments, the motor 26 includes a plurality of motors that are configured to rotate in a clockwise direction, a counter-clockwise direction, or a combination thereof. According to other inventive embodiments, the second motor may connect to the shaft 24 through the first end 14 of the container 12. According to some inventive embodiments, the mixing apparatus additionally includes a shaft holder 28, which may be fixed to the first end 14 of the container 12 within the volume V to provide stability and additional strength of the shaft 24. According to other inventive embodiments, the shaft holder 28 extends from the shaft 24 and is configured to contact the interior side of the first end 14 of the container 12 when the mixing apparatus 20 is in a different position. While the shaft holder 28 is coupled to the shaft 24, it is configured to not rotate with the shaft 24. When the motor 26 has enough power and the shaft 24 is supported firmly, the holder 28 is optional.

As noted above, the mixing apparatus 20 may include one to several blades 21. One to five blades are usually sufficient for a less than 300-gallon container. Large volume containers typically need more blades. For covering more volume and area, two cross pieces with plastic, metal or stainless-steel material over these blades may be used wholly or partially. The cross pieces may be covered to its top part and not bottom part to reduce resistance during turning for high viscosity at its bottom part. In the sloped position, materials spread onto more areas of the container. When more viscous materials are located at the bottom of the volume V, its viscosity increases and has more turning resistance. In such situations, the motor may require more power. The two cross pieces may increase blade diameter to cover more area and volume.

According to some inventive embodiments, the container 12 is formed of plastic, general metal, stainless steel, or mixed materials. According to still other inventive embodiments, the volume V of the container 12 is usually from 0.3 gallons to 500 gallons. According to still other inventive embodiments, the second end 18 of the container 12 is an opening or closing that is positioned opposite to the first end 14 of the container 12. According to other embodiments, the second end 18 of the container 12 is a lid that is fixed to or removable from the side wall 16 of the container. According to such embodiments, the second end 18 includes a through hole 19 formed therein through which the shaft 24 of the mixing apparatus 20 passes. According to still other inventive embodiments in which the second end 18 is fixed with hole(s) or removable from the side wall 16, the interface between the second end 18 and the side wall 16 is leak proof, for example including together or a sealable gasket.

According to some embodiments, the container mixer 10 additionally includes an input port 13 positioned near the second end 18 of the container 12. The input port 13 is configured to pass a liquid material into the volume V of the container 12 from outside the container. According to other embodiments, the container mixer 10 additionally includes an outlet port 15 positioned near the first end 14 for vertical position or near the second end 18 for horizontal position of the container 12. The outlet port configured to pass a mixed material, such as a manufactured emulsion product, from inside the volume V to outside the container 12. A liquid pump is another option to transfer the emulsion product.

According to other embodiments, the container 12 additionally includes a temperature control jacket (not shown) configured to control the temperature of the container 12 and to help regulate the heating and cooling of the contents contained within the volume V. According to still other embodiments, the temperature control jacket is positioned on the exterior of the container 12, the interior of the container 12, or a combination thereof.

According to other inventive embodiments, such as in FIG. 2, the inventive drum mixer 10 additionally includes a frame 30 that is configured to support the container 12 and facilitate movement of the drum 12 from a vertical position to a sloped position or a horizontal position. According to other inventive embodiments, the frame 30 includes at least one leg 32 configured to support a side wall 16 of the drum 12.

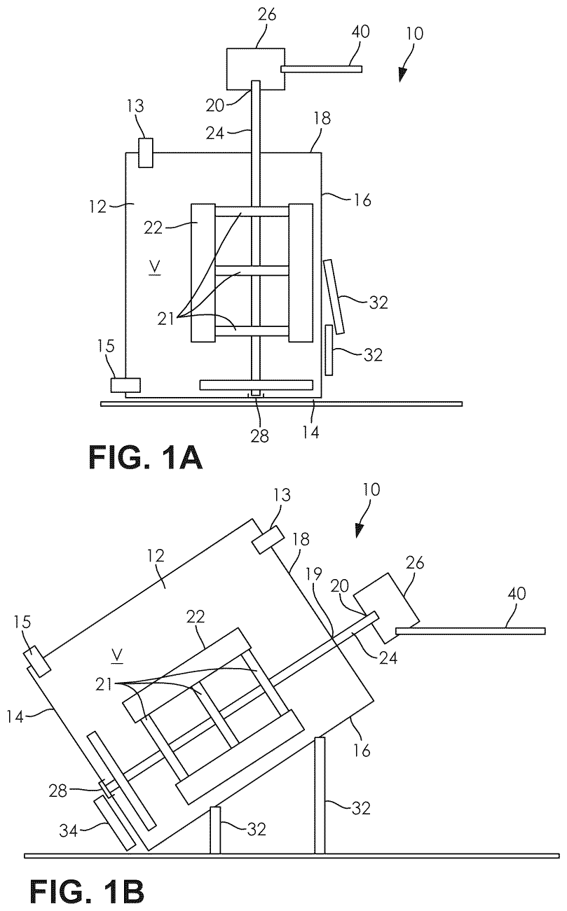

According to some embodiments, as shown in FIGS. 1A and 1B, the at least one leg 32 is hinged to the side wall 16 of the container 12 so that when the container 12 is in the vertical position the leg 32 is positioned generally parallel to the side wall 16 of the container, but when the container 12 is moved to the sloped position the leg 32 moved away from the side wall 16 of the container so that it can support the container 12 in the sloped position. According to still other embodiments, the leg 32 is removable from the side wall 16 of the container so that it is not in the way when the container 12 is in the horizontal position, as shown in FIG. 1C. According to other inventive embodiments, FIG. 2 shows the frame 30 includes at least one stopper 34 configured to support the first end 14 of the drum 12. According to still other embodiments, the stopper 34 is removable from the container 12 so that it is only present when the drum 12 is in the sloped position. According to some embodiments, the frame 30 includes a pivot point 36 located between the at least one leg 32 and the stopper 34. The pivot point 36, in some embodiments, is a wheel. According to some embodiments, when the container 12 and the mixing apparatus 20 are converted from the vertical position to the sloped or horizontal position, the stopper 34 is set at the first end 14 of the container 12 to provide stability to the container 12. According to other inventive embodiments, the movement of the container 12 between the vertical position and the horizontal position is accomplished manually or by mechanical means including piston cylinders, pullies, ratcheting, and the like for large volume production. A computer operated controller may also be configured to actuate the movement of the container 12 between the various positions and other related operations.

According to some embodiments, the motor power and speed, oil phase addition into the container, water phase addition into the container, and position control may be controlled manually, semi-automatically or automatically. According to other inventive embodiments, the container mixer 10 may include a control panel to control these related parameters.

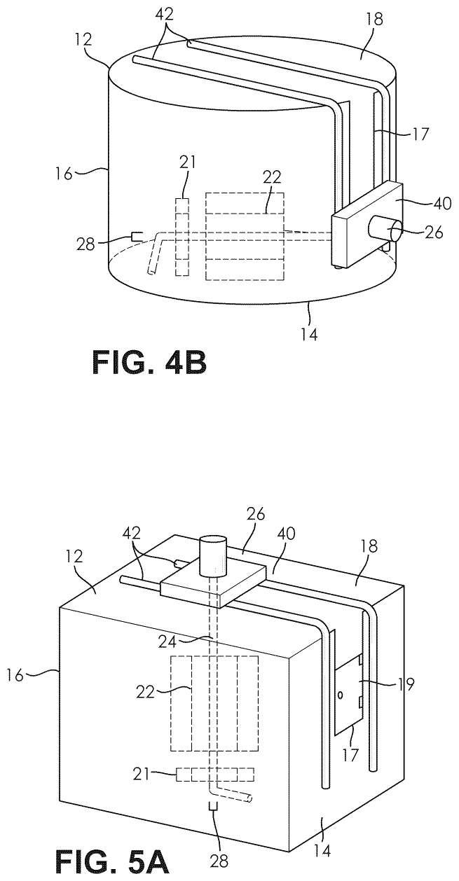

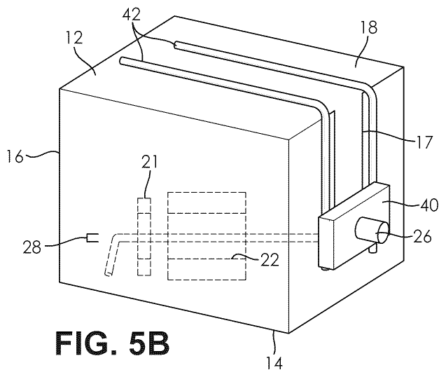

According to some embodiments, such as in FIGS. 4A and 4B, the mixing apparatus 20 is moveable relative to the container 12 between a vertical position where the shaft 24 is inserted through the second end 18 of the container 12 and a horizontal position wherein the shaft 24 is inserted through a through hole 17 in at least one side wall 16 of the container 12. According to other inventive embodiments, when the container 12 includes a through hole 17 in the side wall 16 of the container, the inventive drum mixer 10 also includes a cover 19 configured to seal the through hole 17 in the side wall 16 of the container 12 when the mixing apparatus 20 is in a position other than the horizontal position. According to still other embodiments, the cover 19 is a cover that is configured to be attached to the side wall 16 of the container 12 using fasteners, is a door connected to the side wall 16 of the container 12 by hinges or is a slidable arrangement. According to still other embodiments, the cover 19 includes a gasket that ensures that the cover 19 prevent leaks from the volume V of the container 12 through the through hole 17. According to still other embodiments, the through hole 17 in the side wall 16 extends through the side wall 16 to the second end 18 of the container 12, such as shown in FIGS. 4A and 4B.

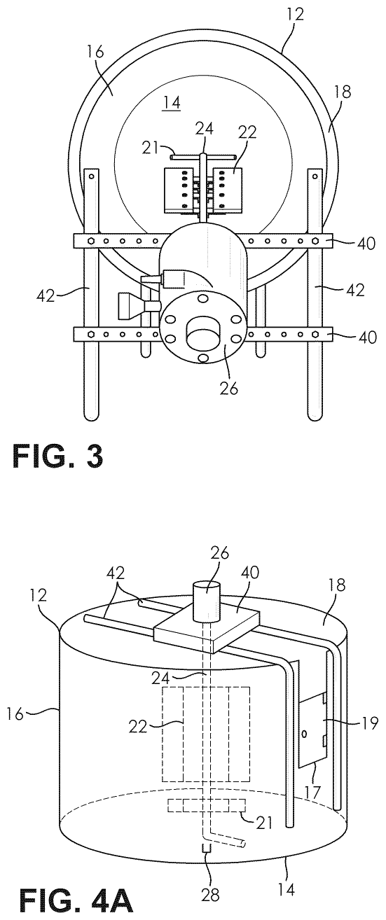

According to some embodiments the mixing apparatus 20 additionally includes a support structure 40 that is configured to adjust the position of the mixing apparatus 20 relative to the container 12. According to other inventive embodiments, the support structure 40, on which the motor 26, shaft 24, and blade 21 are supported, is movable relative to the container 12 to position the shaft 24 and at least one blade 21 relative to at least one of a first end 14 of the container 12 and a central axis of the container 12. In this way, the height of the blade 21 and the concentricity of the shaft 24 may be adjusted relative to the container 12. As such, according to some embodiments, the shaft 24 of the mixing apparatus 20 is concentric with a central axis of the container 12 or may be positioned eccentric with a central axis of the container 12. According to still other embodiments, the support structure 40 is configured to adjust the position of the mixing apparatus 20 between the vertical position and the horizontal position, as shown in FIGS. 4A and 4B. To facilitate movement of the support structure 40 relative to the container 12, the support structure 40 may include at least one track 42 upon which the support structure 40 is supported and moves. According to still other embodiments, the at least one track 42 is attached to the container 12. According to other inventive embodiments, the support structure 40 includes a locking mechanism to maintain the position of the support structure 40 relative to the track 42. According to still other embodiments, the locking mechanism is a clamp, a brake, a pin configured to be passed through a hole in the track 42, or the like. As shown in FIGS. 2 and 3, the track 42 according to some embodiments extends over only the second end 18 of the container 12. According to other embodiments, such as shown in FIGS. 4A and 4B, the track 42 extends over both the second end 18 of the container 12 and the side wall 16 of the container 12.

According to embodiments, a large container such as tote or large tank with such as more than 300 gallons are heavy, which is usually difficult to be moved to change its position. Motor(s) and mixed liquid are additional weight. One optional way is to use both horizontal and vertical mixers through the holes in the second end 18 and side wall 16 without moving the heavy large container. Leakage is still a challenge, which may be improved with good seal or stop cap(s) after removing the horizontal mixer(s) for high viscous liquid or gel. Vertical mixer is used for low viscous liquid. The second end 18 of the container may be open for more options.

According to some embodiments, the inventive container mixer 10 is used to produce an emulsion that undergoes a viscosity change during its formation. When the mixer 10 with optional vertical, sloped (between 0-90 degrees), and horizontal positions is used, the sloped or vertical positions are typically used for mixing low viscosity liquids, while the sloped or horizontal positions are used for mixing high viscosity gels or semi solids.

According to some embodiments, the mixing apparatus 20 is usually set onto the support structure 40 and connects the shaft of a motor. The support structure 40 may also be connected or fixed onto a floor with its stability for large volume production. Next, water is added to the volume V of the container 12. Then a surfactant is added to the volume V gradually during mixing to form a creamy mixture. Another option is to premix water and a surfactant before pouring into the volume V of the container for mixing and forming a creamy mixture. There are four types of surfactants based upon the composition of polarity of the head group: nonionic, anionic, cationic and amphoteric surfactants. Decyl glucoside, polysorbate 80, polysorbate 20, sodium C₁₄₋₁₆ olefin sulfonate, and odium cocoamphoacetate are common surfactants. Inclusion thereof in the mixture promotes for better function.

Next, the oil phase is added gradually to the volume V of the container 12 during mixing. The viscosity increases from low to high, which is usually handled when the container 12 or the mixing apparatus 20 is positioned in the sloped position. The motor power and speed are adjusted for its proper operation. The motor at the sloped position needs much less power than the two mixing motors for the two vertical mixers. When desired, the container 12 or the mixing apparatus 20 can be moved to the horizontal position to provide even more mixing area and volume. When the horizontal position is used, leakage from the container 12 around the shaft holder needs to be considered. This is where the sealing using the cover 19 is useful or providing a gasket around the shaft 24 is also beneficial or its liquid level does not reach to its hole level. According to some embodiments, the container 12 or mixing apparatus 20 is moved from the horizontal position before the level of the materials contained in the volume V reach the level of the shaft 24 of the mixing apparatus, for example by moving the container 12 or the mixing apparatus to the sloped or vertical position to avoid the leakage.

Next, water phase is added gradually to the volume V of the container 12 during mixing. As the water phase is added, the viscosity is decreased from high to middle and low, which is usually handled with the container 12 or mixing apparatus in the sloped position or the vertical position. Then the container 12 or mixing apparatus 20 is moved to vertical position because of low viscosity and avoiding liquid leakage. Water phase is continued to be added to the volume V until a final solid level at such as 60%-30% is reached. According to other inventive embodiments, a preservative or biocide is added and mixed to stabilize the emulsion product without a microorganism problem. Two or more positions of vertical, slope, and horizontal positions may be used for the emulsion process. Then the emulsion product is tested to determine characteristics of the emulsion, such as particle size, solid level, pH, viscosity, and stability. The separation may be tested over time.

Notably, homogenization, high speed, and high pressure, which are commonly used in emulsion processes and which have high costs associated therewith, are not needed with the novel mixer 10 of the present invention. As such, process equipment and costs can be reduced significantly when using the inventive container mixer 10.

### EXAMPLES

The following emulsion product processes are examples using embodiments of the inventive mixer 10. It is to be understood, however, that these examples are provided by way of illustration and nothing therein should be taken as a limitation upon the invention.

### Example 1

A 5-gallon bucket with 3 mixing blades and shaft is set onto a supporter. Its slope degree is about 20 degrees. A motor is connected to its shaft with ½ inch dimeter. A stopper is set to the bucket bottom to fix the bucket position without moving. Next, 490 grams of water is poured into the 5-gallon bucket through its top funnel. The motor is run at middle or low speed and continued at about 100 RPM. Next, 490 grams of surfactant is gradually poured in during its mixing. Viscosity is low. A valve from an oil phase container is opened and poured into the 5-gallon bucket gradually during its mixing. The viscosity is increased gradually and gel and semi solid product with high viscosity is formed.

Water is then poured into the 5-gallon bucket gradually from a water container by controlling a valve during its mixing. Then its viscosity is reduced gradually. The motor speed and power are adjusted to mix the mixture. Then the 5-gallon bucket is converted from its sloped position to a vertical position. Water is continued to be added into the 5-gallon bucket gradually by controlling the valve during its mixing. A preservative is finally added and mixed to stabilize its final emulsion product. Two positions of slope and vertical positions are used during its process.

### Example 2

A 7-gallon bucket with 3 mixing blades and shaft is set onto a supporter. Its slope degree is about 15 degrees. A motor is connected to its shaft with ½ inch dimeter. A stopper is set to the bucket bottom to fix the bucket position without moving. Next, 570 grams of water is poured into the 7-gallon bucket through its top funnel. The motor is run at middle or low speed and continued at about 100 RPM. Next, 570 grams of surfactant is poured gradually during its mixing. Viscosity is low. A valve from an oil phase container with related organic chemicals is opened and pours into the 7-gallon bucket gradually during its mixing. The viscosity is increased gradually and a gel and semi solid product with high viscosity is formed.

Water is then poured into the 7-gallon bucket gradually by controlling a valve during its mixing. The viscosity is reduced gradually. Its motor speed and power were adjusted to mix the mixture. Then the 7-gallon bucket is converted from its sloped position to vertical position. Water is continued to be added into the 7-gallon bucket gradually by controlling a valve during its mixing. A biocide (preservative) is added and mixed to stabilize its final emulsion product. Two positions of slope and vertical positions were used during its process.

### Example 3

A 55-gallon drum with 4 mixing blades, 2 cross pieces over these blades, shaft, and motor is set onto a drum truck. Its slope degree is about 25 degrees. Next, water is poured into the 55-gallon drum. The motor is run at middle or low speed and continued at about 80 RPM. Next, a surfactant is gradually poured in during its mixing. Viscosity is low. A valve from an oil phase container is opened and poured into the 55-gallon drum gradually through a plastic tube (1 inch internal diameter) during its mixing. The viscosity is increased gradually and a gel and semi solid product with high viscosity is formed. The horizontal position is also used when viscosity is very high, which reduced motor speed.

Water is poured into the 55-gallon drum gradually by controlling a valve through a plastic tube (1 inch internal diameter) during its mixing. The viscosity is reduced gradually. Its motor speed and power are adjusted to mix the mixture. Then the 55-gallon drum is converted from its sloped position to vertical position. Water is continued to be added into the 55-gallon drum gradually by controlling a valve during its mixing. A biocide (preservative) is added and mixed to stabilize its final emulsion product. Three positions of slope, horizontal, and vertical positions were used during its process.

Patent documents and publications mentioned in the specification are indicative of the levels of those skilled in the art to which the invention pertains. These documents and publications are incorporated herein by reference to the same extent as if each individual document or publication is specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A container mixer comprising:
a single container defining a volume therein, the volume configured to receive and contain a plurality of materials, the container being moveable between a vertical position and a horizontal position;
a mixing apparatus comprising at least one blade disposed on a shaft that is rotatably driven by a motor, the at least one blade being positioned within the volume of the container and configured to rotate therein to mix the plurality of materials within the volume of the container; and
a frame configured to support the container and facilitate movement of the container from the vertical position to the horizontal position.

2. The container mixer of claim 1 wherein the container has a first end and at least one side wall extending from the first end.

3. The container mixer of claim 2 wherein the container additionally has a second end with a through hole therein through which the shaft of the mixing apparatus passes.

4. The container mixer of claim 1 wherein the container additionally has a sloped position that is between the vertical position and the horizontal position.

5. The container mixer of claim 1 wherein the shaft of the mixing apparatus is concentric with an axis of the container.

6. The container mixer of claim 1 wherein the mixing apparatus further comprises a support structure configured to adjust the position of the shaft and the at least one blade relative to at least one of a first end of the container and an axis of the container.

7. The container mixer of claim 1 wherein the frame includes at least one leg configured to support a side wall of the container.

8. The container mixer of claim 1 wherein the frame includes at least one stopper configured to support a first end of the container.

9. The container mixer of claim 1 further comprising an input port positioned near a second end of the container, the input port configured to pass a liquid material into the volume of the container from outside the container.

10. The container mixer of claim 1 further comprising an outlet port positioned near a first end of the container, the outlet port configured to pass a mixed material from inside the volume to outside the container into a product container.

11. A container mixer comprising:
a single container having a first end, at least one side wall extending from the first end, and a second end, the container defining a volume therein, the volume configured to receive and contain a plurality of materials, the at least the second end one side wall having through hole therein;
a mixing apparatus comprising at least one blade disposed on a shaft that is rotatably driven by a motor, the at least one blade configured to be positioned within the volume of the container and configured to rotate therein to mix the plurality of materials within the volume of the container, the mixing apparatus being moveable relative to the container between a vertical position where the shaft is inserted through the second end of the container and a horizontal position wherein the shaft is inserted through the through hole in the at least one side wall of the container.

12. The container mixer of claim 11 wherein the mixing apparatus further comprises a support structure configured to adjust the position of the mixing apparatus between the vertical position and the horizontal position.

13. The container mixer of claim 11 further comprising a cover configured to seal the through hole in the at least one side wall of the container.

14. The container mixer of claim 11 wherein the through hole in the at least one side wall of the container extends to the second end of the container.

15. The container mixer of claim 11 further comprising an input port positioned near the second end of the container, the input port configured to pass a liquid material into the volume of the container from outside the container.

16. The container mixer of claim 11 further comprising an outlet port positioned near the first end of the container, the outlet port configured to pass a mixed material from inside the volume to outside the container into a product container.

17. A container mixer comprising:
a single container defining a volume therein, the volume configured to receive and contain a plurality of materials, the container having both vertical and horizontal mixers for a large container production;
a mixing apparatus comprising at least one blade disposed on a shaft that is rotatably driven by a motor, the at least one blade being positioned within the volume of the container and configured to rotate therein to mix the plurality of materials within the volume of the container; and
a frame configured to support the mixers at the vertical and horizontal positions.

18. The container mixer of claim 17 wherein the container has mixer shaft holder(s) on one side wall to hold the shaft(s) and another side wall hole(s) or open to through the shaft(s).

19. The container mixer of claim 17 wherein facilitating its cap(s) to stop potential leakage when horizontal mixer(s) are not used.

20. The container mixer of claim 17 wherein the production volume has volume at least 200 gallons.
